(19) United States
(12) Patent Application Publication
(10) Pub. No.: US 2006/0003846 A1
(43) Pub. Date: Jan. 5, 2006

(54) Device for recognizing a shaft break

(75) Inventors: Frank Burger, Duren (DE); Norbert Ludwig, Bruggen (DE)

Correspondence Address: GRIFFIN & SZIPL, PC, SUITE PH-1, 2300 NINTH STREET, SOUTH, ARLINGTON, VA, 22204, US

(73) Assignee: Pierburg GmbH, Neuss (DE)

(21) Appl. No.: 11/155,895

(22) Filed: Jun. 20, 2005

(30) Foreign Application Priority Data
Jun. 19, 2004 (DE) 10 2004 029 748.7

(51) Int. Cl. G08B 23/00; F16C 3/06

(52) U.S. Cl. 464/23; 415/13

(57) ABSTRACT

The invention relates to a device for recognizing a shaft break of an actuated shaft made of plastic, in which a conductor is injected. This conductor extends essentially over the entire axial length of the shaft, whereby both its ends are connected to an electronics unit, so that upon a break of the shaft, and thus of the conductor, a current flow is interrupted and the conclusion can be drawn that the shaft has broken. According to the invention, the contacting of the conductor ends takes place via two electrically conductive rings arranged on the shaft, which rings in turn produce the contact to the electronics unit via carbon brushes arranged on sheet-metal springs.

The present application claims priority on DE 10 2004 029 748.7 filed Jun. 19, 2004, the entire disclosure of which is incorporated herein by reference.

### FIELD OF THE INVENTION

The present invention relates to a device for recognizing a shaft break of a shaft to be actuated, wherein the device is made of a non-conductive plastic and in which a conductor is injected that extends essentially over the entire length of the shaft in the axial direction, and is connected electrically to an electronics unit so a current flow through the conductor is interrupted when the shaft breaks.

### BACKGROUND OF THE INVENTION

A device for recognizing a shaft break is described, for example, in German Document DE 102 15 927 A1. Here, too, a conductor is injected into the shaft and extends over the entire length of the shaft in the axial direction. The electrical connection to a ground, or to the electronics unit, is produced by electrically conductive bearings in which the shaft is supported, as well as by bushes that surround the bearings, so when a break of the shaft occurs there is a break of the conductor and the current flow between the electronics unit and the ground is interrupted.

However, the device of German Document DE 102 15 927 A1 has the disadvantage that electrically conductive bushes must be used, and the contacting is produced via rotating rolling-contact bearings, or ball bearings, so a reliable constant contacting between the two ends of the conductor and the bearings is not ensured.

### SUMMARY OF THE INVENTION

Thus, an object of the present invention is to produce a reliable constant contacting between the conductor and the electronics unit that works reliably even when wear, or imbalance, of the shaft occurs. Moreover, the assembly, in accordance with the present invention, is facilitated and independence from the bearing material is achieved while simultaneously reducing cost.

This object is attained by the present invention because the conductor features two ends connected, respectively, in an electrically conductive manner to a ring of electrically conductive material, whereby the rings feature (i) a free outer peripheral surface, (ii) revolve with the shaft, and (iii) are in electrical contact with the electronics unit via carbon brushes. Such an arrangement effects a constant secure contact, both in the area between the conductor and the co-revolving rings and from the rings to the electronics unit, via the carbon brushes. The manufacture and assembly of such a device is extremely simple and cost-effective.

In an illustrative embodiment, the carbon brushes are arranged on electrically conductive sheet metal springs via which the electrical connection to the electronics unit is produced. A constantly sufficient pressure of the carbon brushes on the rings is exerted by means of these sheet-metal springs, and thus, the contacting is ensured even when vibrations or imbalances during use, and wear of the carbon brushes, occur.

In another embodiment, in accordance with the present invention, the rings are made of metal and are injected into the shaft, through which means a cost-effective and simple-to-produce arrangement is achieved, whereby the contacting between the rings and the conductor is ensured with a long service life.

In yet another embodiment, in accordance with the present invention, the two rings are arranged at a first shaft end and the conductor extends from the first shaft end to a second shaft end and is led back to the first shaft end via a 180° deflection. This structure has the advantage that the brushes with the sheet-metal springs are both arranged on one side of the shaft, and thus, the contacting to the electronics unit can be produced simply without further cables. Consequently, the fixing of the brushes is simplified.

Through these embodiments, according to the present invention, an extremely simple and cost-effectively constructed device for recognizing a shaft break is provided in which a constant and reliable contacting between the conductor and the electronics unit is ensured. Due to the low current flow in the conductor, the wear of the carbon brushes is also kept extremely low. An independence from the bearing material is also achieved by the present invention.

In accordance with the above objects there is provided an apparatus for recognizing a shaft break of a shaft, comprising (a) a non-conductive plastic; (b) a conductor, having first and second ends, injected in the non-conductive plastic, extending essentially over an entire length of the shaft in an axial direction of the shaft; (c) an electronics unit to which the conductor is electrically connected so that a current flow through the conductor is interrupted when the shaft breaks; (d) first and second rings of electrically conductive material, connected, respectively, to the first and second ends of the conductor, wherein the rings include a free outer peripheral surface, are disposed to rotate with the shaft; and (e) carbon brushes disposed to form an electrical connection between the electronics unit and the rings.

In accordance with a further embodiment, there are further provided electrically conductive sheet-metal springs on which the carbon brushes are arranged and via which the electrical connection to the electronics unit is produced.

In accordance with a still further embodiment, the rings are metal and are injected into the shaft.

In accordance with yet another embodiment, the shaft has first and second ends, the first and second rings are arranged on the first shaft end, and wherein the conductor extends from the first shaft end to the second shaft end and is led back to the first shaft end via a 180° deflection.

An exemplary embodiment is shown in the drawings and is described below.

Further objects features and advantages of the present invention will become apparent from the Detailed Description of Illustrative Embodiments, which follows, when considered together with the attached Drawings.

### BRIEF DESCRIPTION OF THE DRAWINGS

FIG. 1 shows, in side view, a schematic representation of a device according to the invention for recognizing a shaft break.

FIG. 2 shows a front view of the device, according to the embodiment shown FIG. 1, for recognizing a shaft break.

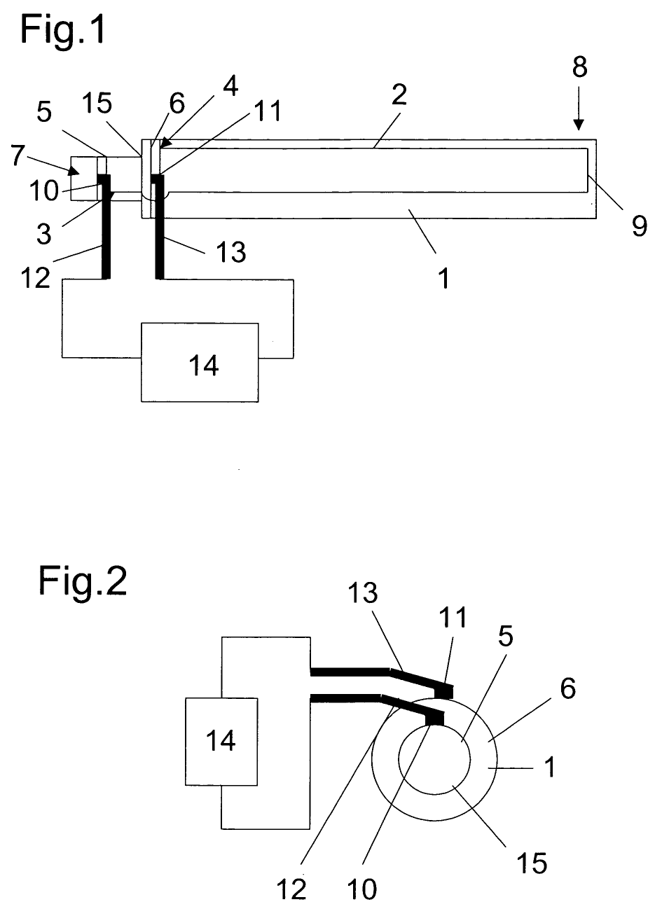

### DETAILED DESCRIPTION OF ILLUSTRATIVE EMBODIMENTS

The device shown in the Figures for recognizing a shaft break is composed of a shaft 1 that is made of a non-conductive plastic and into which a conductor 2 is injected. The shaft is set into rotary motion via an adjusting device, not shown, and can be supported in any desired manner.

This shaft can, for example, be a shaft in an internal combustion engine bearing a flapper valve.

The conductor 2 features a first end 3 and a second end 4, and extends essentially over the entire axial length of the shaft 1. In the present exemplary embodiment, the first conductor end 3 is electrically connected to a first metal ring 5 and the second conductor end 4 is electrically connected to a second metal ring 6. Both metal rings 5 and 6 are situated on a first shaft end 7, whereby the conductor 2 extends from the first shaft end 7, or from the first ring 5, to a second shaft end 8, and then led back via a 180° deflection 9 to the first shaft end 7 and to the second ring 6. In particular, electrical contact exists only between the first conductor end 3 and the first ring 5 and between the second conductor end 4 and the second ring 6.

Carbon brushes 10, 11 rest respectively on the metal rings 5, 6, and these carbon brushes 10, 11 are arranged and fixed on sheet-metal springs 12, 13. An electrical contact to an electronics unit 14 is produced via these sheet-metal springs 12, 13.

In the present exemplary embodiment, the shaft 1 features a step 15, whereby the first ring 5 is arranged in the area of the smaller shaft diameter and the second ring 6 is arranged in the area of the larger shaft diameter. As a result of this shaft configuration, the arrangement of the conductor 2 in the shaft 1, and the conductor's contact with the rings 5, 6, is facilitated.

A low voltage between the two carbon brushes 10, 11 is now generated by the electronics unit 14 so that a low current flow through the conductor 2 results. If the shaft 1 were to break, then the conductor 2 injected into the shaft 1 would break simultaneously; consequently, the current flow between the conductor ends 3, 4 would likewise be interrupted. When the current flow between the conductor ends 3, 4 is interrupted, a conclusion can be drawn by the electronics unit 14 that the shaft has broken.

By means of the carbon brushes 10, 11 that run on the rings 5, 6, a very simple and secure contact between the rings 5, 6 and the carbon brushes 10, 11 is achieved. The arrangement of the carbon brushes 10, 1 1 on the sheet-metal springs 12, 13 causes the carbon brushes 10, 11 to be pressed constantly on the rings 5, 6 with a defined force via the spring action of the sheetmetal springs 12, 13. Consequently, even if the brushes 10, 11 are worn by current flow, the wear is very small due to the low current flow and a secure and reliable contact is guaranteed.

A device for recognizing a shaft break, in accordance with the present invention, is extremely simple and cost-effective to produce and to assemble, whereby simultaneously the reliable operation of the device is ensured over a long service life without being limited in the selection of the bearing elements used, or the arrangement of the bearing elements in bushes or in the housing.

It should be clear to those skilled in the art that the arrangement of the rings on the shaft, and thus of the carbon brushes, can be embodied at different positions along the axial length of the shaft, without departing from the scope of the present invention, as long as the conductor essentially extends over the entire axial length of the shaft. Moreover, a device for recognizing a shaft break, in accordance with the present invention, can be used for various applications in which the recognition of a shaft break is desired. The type of bearing, or drive of the shaft, is not significant and does not limit the present invention. The electrically conductive material of the rings can also be selected freely from suitably conductive material without departing from the scope of the present invention.

While the present invention has been further elucidated by means of certain illustrative embodiments, one of ordinary skill in the art will recognize that additions, deletions, substitutions and improvements can be made while remaining within the scope of the present invention as defined by the attached claims.

1. An apparatus for recognizing a shaft break of a shaft, comprising,
(a) a shaft comprising a non-conductive plastic;
(b) a conductor comprising two ends, wherein the conductor is injected in the non-conductive plastic and extends essentially over an entire length of the shaft in an axial direction of the shaft;
(c) an electronics unit electrically connected to the conductor so a current flows through the conductor and is interrupted when the shaft breaks; and
(d) two rings of electrically conductive material connected, respectively, in an electrically conductive manner to the two ends of the conductor, wherein each ring includes a free outer peripheral surface, is disposed to rotate with the shaft, and is in electrical contact with the electronics unit via a carbon brush.

2. The apparatus for recognizing a shaft break according to claim 1, further comprising electrically conductive sheet-metal springs, wherein the carbon brushes are arranged on the sheet-metal springs to produce an electrical connection to the electronics unit.

3. The apparatus for recognizing a shaft break according to claim 1, wherein the rings are metal and are injected into the shaft.

4. The apparatus for recognizing a shaft break according to claim 2, wherein the rings are metal and are injected into the shaft.

5. The apparatus for recognizing a shaft break according to claim 1, wherein the shaft has a first shaft end and a second shaft end, and the rings are arranged on the first shaft end and the conductor extends from the first shaft end to the second shaft end and is led back to the first shaft end via a 180° deflection.

6. The apparatus for recognizing a shaft break according to claim 2, wherein the shaft has a first shaft end and a second shaft end, and the rings are arranged on the first shaft end and the conductor extends from the first shaft end to the second shaft end and is led back to the first shaft end via a 180° deflection.

7. The apparatus for recognizing a shaft break according to claim 3, wherein the shaft has a first shaft end and a second shaft end, and the rings are arranged on the first shaft end and the conductor extends from the first shaft end to the second shaft end and is led back to the first shaft end via a 180° deflection.

8. The apparatus for recognizing a shaft break according to claim 4, wherein the shaft has a first shaft end and a second shaft end, and the rings are arranged on the first shaft end and the conductor extends from the first shaft end to the second shaft end and is led back to the first shaft end via a 180° deflection.
